(19) United States
(12) Patent Application Publication
(10) Pub. No.: US 2026/0124651 A1
(43) Pub. Date: May 7, 2026

(54) METHOD FOR THE INCINERATION OF WASTE CONTAINING FLUORINE AND NOBLE METALS

(71) Applicant: HERAEUS PRECIOUS METALS GMBH & CO. KG, Hanau (DE)

(72) Inventors: Christian NOWOTTNY, Hanau (DE); Thomas OEHMEN, Hanau (DE); Dieter SCHÄFER, Hanau (DE)

(21) Appl. No.: 19/119,003

(22) PCT Filed: Sep. 28, 2023
(86) PCT No.: PCT/EP2023/076837

§ 371 Date: Apr. 7, 2025

(30) Foreign Application Priority Data
Oct. 12, 2022 (EP) 22200988.8

(51) Int. Cl. B09B 3/40; B09B 101/15; B09B 101/30; C22B 7/00; C22B 11/02; H01M 8/008

(52) U.S. Cl. CPC B09B 3/40; C22B 7/001; C22B 11/023; H01M 8/008; B09B 2101/15; B09B 2101/30

(57) ABSTRACT

A method for the incineration of waste containing fluorine and noble metals in a chamber furnace, the fluorine content of the waste lying in the range of >5 to 70 wt. %, and the noble metal content of the waste lying in the range of 0.1 to 30 wt. %, and the furnace chamber of the chamber furnace being lined with a chromium corundum material comprising ≥80 wt. % alpha-Al₂O₃, 1 to 20 wt. % Cr₂O₃ and 0 to 5 wt. % SiO₂.

The invention relates to a method for the incineration of waste containing fluorine and noble metals. The noble metal-enriched ash residue obtained after the method has been carried out can be processed to recover the noble metal contained therein.

The term “noble metal” is used herein. Noble metals within the meaning of the present invention are silver, ruthenium, rhodium, palladium, iridium and platinum, each one alone or in any combination of two, a plurality of or all of these metals.

EP 2 700 726 A 1 discloses a method for the incineration of waste containing fluorine and noble metals with the aim of enriching noble metals. When such waste is incinerated, hydrogen fluoride or hydrofluoric acid is produced, among other things. As a thermal treatment plant in which the incineration takes place, EP 2 700 726 A 1 discloses a chamber furnace with a refractory insulation lining in the form of a ramming mass in the interior of the furnace chamber, wherein the refractory insulation lining has a high proportion of aluminum oxide of 85 wt. % (weight %) or more, in particular of 88 wt. % or more. In addition to aluminum oxide, the refractory insulation lining can also comprise calcium oxide and silicon dioxide in varying proportions. Despite the proportion of up to 15 wt. %, in particular up to 12 wt. % of calcium oxide and/or silicon dioxide in the ramming mass, according to EP 2 700 726 A 1 it is not corroded by hydrofluoric acid. EP 2 700 726 A 1 states that the disclosed method is preferably suitable for processing materials which have a fluorine content of up to 5 wt. %. Preferably, the waste materials used in the method that are to be subjected to heat treatment are fluoroorganic materials, PTFE films, fuel cells, catalysts and/or pastes. In principle, the method is suitable for all materials having a fluorine content of up to 5 wt. %, which decompose at a temperature of approximately 800° C., in particular of approximately 600° C., i.e., below, but at the latest when said temperature of approximately 800° C., in particular of approximately 600° C., is reached.

The object of the present invention was that of finding a method, used for the enrichment of noble metals, for the incineration of waste containing fluorine and noble metals with a particularly high fluorine content. It had been found that the method known from EP 2 700 726 A 1 reaches its limits as soon as the fluorine content in the material containing fluorine and noble metals to be incinerated exceeds 5 wt. %, in particular if this is regularly the case, for example, for each or substantially each batch.

The object could be achieved by virtue of a method for the incineration of waste containing fluorine and noble metals in a chamber furnace, the fluorine content of the waste lying in the range of >5 to 70 wt. %, and the noble metal content of the waste lying in the range of 0.1 to 30 wt. %, and the furnace chamber (the furnace space, the furnace interior) of the chamber furnace being lined with a chromium corundum material comprising ≥80 wt. % alpha-Al₂O₃, 1 to 20 wt. % Cr₂O₃ and 0 to 5 wt. % SiO₂.

The method according to the invention comprises the successive steps of: (1) introducing waste containing fluorine and noble metals to be incinerated, which waste has a fluorine content in the range of >5 to 70 wt. % and a noble metal content in the range of 0.1 to 30 wt. %, into the furnace chamber of a chamber furnace, (2) incinerating the waste, and (3) removing the ash formed after the completion of step (2), the furnace chamber of the chamber furnace being lined with a chromium corundum material comprising ≥80 wt. % alpha-Al₂O₃, 1 to 20 wt. % Cr₂O₃ and 0 to 5 wt. % SiO₂.

If the fluorine content and/or the noble metal content of waste containing fluorine and noble metals to be incinerated by means of the method according to the invention is not directly known, it/these can be determined using conventional analytical methods known to a person skilled in the art. A person skilled in the art will choose the analytical method(s) depending on the type of waste. If necessary, the waste can first be homogenized—at least macroscopically. The fluorine content of a waste sample can be determined, for example, by combustion digestion (pyrohydrolysis) followed by ion chromatography (combustion IC). To determine the noble metal content, a waste sample can be examined directly or after incineration in a laboratory furnace using X-ray fluorescence analysis; alternatively, the noble metal content of the ash can be transferred into an aqueous solution using wet chemicals, for example using aqua regia, and determined using ICP-OES analysis, for example.

The method according to the invention is a discontinuous method; it can be executed in batches, wherein identical, similar or different batches of waste containing fluorine and noble metals to be incinerated can be incinerated one after the other in accordance with the methodology according to the invention, i.e., in accordance with the sequence of steps (1)-(2)-(3). This refers to identical, similar or different batches of waste containing fluorine and noble metals to be incinerated; the individual batches may therefore differ in terms of their qualitative and/or quantitative composition, but they are always batches of waste containing fluorine and noble metals to be incinerated having a fluorine content in the range of >5 to 70 wt. % and a noble metal content in the range of 0.1 to 30 wt. %. In batch operation, the furnace chamber is charged with a batch of waste to be incinerated (introducing a batch of waste to be incinerated into the furnace chamber), the batch of waste is incinerated, removed from the furnace chamber after incineration; then the process characterized by the sequence of steps (1)-(2)-(3) begins again with the next batch of waste. For a person skilled in the art, it goes without saying that the temperature of the furnace chamber of the chamber furnace drops between the removal of an incinerated batch of waste and the re-charging of the furnace chamber with a subsequent batch to be incinerated. Not least for reasons of energy efficiency, however, this cooling of the furnace chamber is preferably kept as minimal as possible and the subsequent batch is fed as quickly as possible. For example, cooling the interior of the furnace chamber to a temperature below the range of 400 to 600° C. is avoided wherever possible. In other words, the method according to the invention can preferably be carried out in continuous operation, not only from the point of view of energy saving, but also with a view to a high level of plant utilization. The term “continuous operation” as used herein refers to a continuous batch-wise repetition of the method according to the invention in the same chamber furnace, preferably with as few interruptions as possible between the particular incineration cycles due to loading and unloading.

The term “incineration” is used herein; it refers to the formation of ash by pyrolysis (thermal decomposition, carbonization) and/or oxidation, wherein this process occurs in particular as combustion. In general, incineration in the method according to the invention includes both pyrolysis and oxidation or combustion, wherein pyrolysis and oxidation processes can take place one after the other or in parallel, if necessary also alternately. This may depend, among other things, on the type of waste containing fluorine and noble metals to be incinerated and its presentation in the furnace chamber, on the temperature control in the furnace chamber and on the air or oxygen supply therein.

A distinction is made herein between the waste containing fluorine and noble metals to be incinerated in the method according to the invention and the waste containing fluorine and noble metals incinerated in the method according to the invention. The waste containing fluorine and noble metals incinerated in the method according to the invention is the product of the method according to the invention, i.e., an ash. The method according to the invention leads to an enrichment of noble metals, and the ash is therefore characterized by a higher noble metal content than that of the original waste containing fluorine and noble metals to be incinerated.

The waste containing fluorine and noble metals to be incinerated in the method according to the invention is not conventional domestic or commercial waste, which may contain fluorine and noble metals in low proportions, for example less than 3 wt. % of fluorine and less than 0.05 wt. % of noble metals. Rather, the waste containing fluorine and noble metals to be incinerated is waste having a comparatively high fluorine content in the range of >5 to 70 wt. % and a comparatively high noble metal content in the range of 0.1 to 30 wt. %, the comparatively high proportion of valuable noble metal not only justifying noble metal recovery, but actually requiring it from the point of view of resource conservation. Thus, the waste containing fluorine and noble metals to be incinerated in the method according to the invention can be, for example, chemical waste such as residues from chemical production such as spent catalysts, synthesis residues, faulty batches, distillation bottoms and the like; fuel cell waste, in particular membrane material from fuel cells; and/or electrolysis cell waste (electrolyzer waste), in particular membrane material from electrolysis cells (electrolyzers). It is clear to a person skilled in the art that the waste containing fluorine and noble metals to be incinerated in the method according to the invention always comprises organic chemical material or organic chemical material components. The term “organic chemical” explicitly includes “organometallic”; organic chemical material or organic chemical material components include not only per- and polyfluorinated chemicals but also organic polymer material, such as fluoropolymer material as a typical representative of membrane material from fuel and electrolysis cells. The organic chemical material may also comprise volatile organic compounds, in particular organic solvents. In addition to the noble metal content and the organic chemical material portion, it may in particular comprise carbon, such as catalyst support material in the form of activated carbon, and/or inorganic material, such as inorganic catalyst support material (for example refractory oxidic material, such as aluminum oxide, silicon dioxide and zeolite). Water can also be included.

In the case of chemical waste in the form of residues from chemical production, the noble metal content generally comes from the noble metal catalysts or degradation products contained therein. In membrane material from fuel and electrolysis cells, the noble metal content usually comes from a catalyst layer containing noble metals and located on the front and/or back of the membrane. As already mentioned, in the membrane material from fuel and electrolysis cells, the fluorine content usually comes from the membrane itself, so the actual membrane material is generally polymers such as polytetrafluoroethylene or so-called ionomers such as in particular copolymers of tetrafluoroethylene and a sulfonic-acid-group-containing (per)fluorovinyl ether, such as Nafion® from Chemours.

The fluorine content of the waste containing fluorine and noble metals to be incinerated in the method according to the invention lies in the range of >5 to 70 wt. %, in particular 15 to 60 wt. %, and its noble metal content lies in the range of 0.1 to 30 wt. %, in particular 0.5 to 8 wt. %. The fluorine and noble metal contents mentioned here are the fluorine and noble metal contents of a particular batch of waste containing fluorine and noble metals to be incinerated. In other words, a batch of waste may be inherently homogeneous—or at least macroscopically homogeneous—waste or it may be a combination of different wastes or types of waste; regardless of this, however, the individual fluorine and noble metal content of each batch of waste containing fluorine and noble metals to be incinerated in the method according to the invention always has a mean value in the range of >5 to 70 wt. %, in particular 15 to 60 wt. %, for the fluorine content and a mean value in the range of 0.1 to 30 wt. %, in particular 0.5 to 8 wt. %, for the noble metal content.

According to the invention, the incineration takes place in a chamber furnace, more precisely in the furnace chamber of a chamber furnace, which is the central element of an incineration plant. In addition to the chamber furnace, the incineration plant may comprise facilities for thermal afterburning. The incineration plant usually comprises an exhaust gas purification system with scrubbers to remove hydrogen fluoride or hydrofluoric acid as well as other pollutants that should not be released into the environment.

The chamber furnace used in the method according to the invention is a conventional chamber furnace, usually with a supporting metal or steel construction or a metal or steel shell of the furnace chamber; what is essential to the invention, however, is that the furnace chamber of the chamber furnace is lined with a chromium corundum material comprising ≥80 wt. % alpha-Al₂O₃, 1 to 20 wt. % Cr₂O₃ and 0 to 5 wt. % SiO₂. For example, the chromium corundum material comprises or consists of 80 to 95 wt. % alpha-Al₂O₃, 1 to 20 wt. % Cr₂O₃ and 0 to 5 wt. % SiO₂. Preferably, the chromium corundum material comprises or consists of 85 to 95 wt. % alpha-Al₂O₃, 2 to 15 wt. %, in particular 5 to 15 wt. %, Cr₂O₃ and 0 to 2 wt. %, in particular 0 wt. %, SiO₂.

The chromium corundum lining is a refractory insulation lining and can be in the form of a ramming mass, as pre-compacted fibers and/or as a chromium corundum brick. The chromium corundum lining can have a thickness typical for a refractory insulation lining in the range of, for example, from 10 to 100 cm. This inner insulation lining serves to protect the supporting metal structure or the metal shell of the furnace chamber in two ways, i.e., in thermal and chemical terms, on the one hand as a long-lasting refractory or thermal insulation, and on the other hand as a long-lasting barrier against hydrogen fluoride or hydrofluoric acid ingress into the metal. What is particularly noteworthy is the comparatively high longevity of the protective effect, as a result of which the method according to the invention can be operated in continuous operation, even though the fluorine content of the waste containing fluorine and noble metals to be incinerated is exceptionally high. In this context, continuous operation means two or more years (for example 2000 or more incineration cycles) without the need for revision or repair or replacement of the insulation lining.

As stated, in step (1) of the method according to the invention, waste containing fluorine and noble metals to be incinerated having a fluorine content in the range of >5 to 70 wt. % and a noble metal content in the range of 0.1 to 30 wt. % is introduced into the furnace chamber, i.e., the furnace chamber is charged therewith. For this purpose, the furnace chamber includes an opening for introducing the appropriate materials. The furnace chamber can be operated with either a deficit of air or an excess of air. As regards the presentation of the waste containing fluorine and noble metals to be incinerated in the furnace chamber, the furnace chamber may have devices inside it for incinerating the waste containing fluorine and noble metals to be incinerated. These include, for example, grates for holding trays for burning solid materials. Thin or viscous materials can be introduced into the furnace chamber either in tanks or via appropriate dosing devices and incinerated in said chamber.

The actual incineration of the waste takes place in step (2) of the method according to the invention. For this purpose, the furnace temperature (the temperature inside the furnace chamber) is set to a temperature suitable for incineration, i.e., it is heated up. The furnace temperature during incineration lies in the range of 650 to 950° C. as a continuous temperature (short-term temperature peaks of up to 1200° C. are possible). The continuous temperature may be a temperature that is substantially constant once it has been reached, or it may be a temperature program that runs within said continuous temperature range. For the purpose of heating to the continuous temperature, all usual methods of energy supply can be used after charging and closing the furnace chamber, i.e., both direct and indirect heating of the furnace chamber, for example gas firing, oil firing and/or electric heating. Indirect heating with hot gas, in particular hot air, is preferred. The heating rate can even reach up to 200° C. per hour, which is comparatively high. Advantageously, the chromium corundum lining proves to be extremely resistant to temperature changes, both in terms of the speed of a temperature change and the frequency of temperature changes.

Incineration of a batch of waste at continuous temperature typically takes between 4 and 15 hours. For a person skilled in the art, it goes without saying that if volatile components such as organic solvents and/or water are present in the waste containing fluorine and noble metals to be incinerated, such volatile components initially evaporate before the actual incineration or during charging of the furnace chamber and/or during the heating process in step (2).

During incineration, a furnace atmosphere is formed with an exhaust gas or from an exhaust gas which, as a result of the high fluorine content of the waste containing fluorine and noble metals to be incinerated, contains a considerable amount of hydrogen fluoride, which with water forms hydrofluoric acid.

In step (3) of the method according to the invention, the ash formed after completion of step (2) is removed from the furnace chamber. The ash is characterized by an enrichment of noble metals compared to the waste containing fluorine and noble metals to be incinerated, i.e., its noble metal content lies, for example, in the range of 0.5 to 60 wt. %. The noble metal can be present in elemental metallic form, as oxide, oxyfluoride and/or fluoride. Furthermore, mineral material may be contained in the ash, for example a mineral material derived from activated carbon material, such as potassium carbonate or a mineral material derived from inorganic catalyst support material, such as the aforementioned refractory oxidic material. Depending on the completeness of the incineration process in step (2), the ash may also comprise portions of coked material, coke and/or coal.

The ash containing noble metals can be processed using conventional methods, in particular wet-chemical methods, for the purpose of noble metal recovery.

In summary, the method according to the invention offers, among others, the following advantages over the prior art represented, for example, by EP 2 700 726A 1:
1. The method according to the invention can be carried out with waste containing fluorine and noble metals despite a high fluorine content of >5 to 70 wt. %, even in continuous operation.
2. The method according to the invention can be carried out at a high heating rate. The rapid temperature changes in the furnace chamber thus made possible allow comparatively short processing times for an individual batch, resulting in rapid batch changes and thus a high capacity in continuous operation (high space/time yield).
3. The method according to the invention can be carried out over many cycles or over a long period of time in continuous operation before an interruption becomes necessary due to necessary revision, repair or a necessary replacement of the chromium corundum insulation lining.

1. A method for the incineration of waste containing fluorine and noble metals in a chamber furnace, wherein the fluorine content of the waste lies in the range of >5 to 70 wt. %, and the noble metal content of the waste lies in the range of 0.1 to 30 wt. %, and wherein the furnace chamber of the chamber furnace is lined with a chromium corundum material comprising ≥80 wt. % alpha-Al₂O₃, 1 to 20 wt. % Cr₂O₃ and 0 to 5 wt. % SiO₂.

2. The method according to claim 1, comprising the successive steps of: (1) introducing waste containing fluorine and noble metals to be incinerated, which waste has a fluorine content in the range of >5 to 70 wt. % and a noble metal content in the range of 0.1 to 30 wt. %, into the furnace chamber of a chamber furnace, (2) incinerating the waste, and (3) removing the ash formed after the completion of step (2), wherein the furnace chamber of the chamber furnace is lined with a chromium corundum material comprising ≥80 wt. % alpha-Al₂O₃, 1 to 20 wt. % Cr₂O₃ and 0 to 5 wt. % SiO₂.

3. The method according to claim 1, wherein the waste containing fluorine and noble metals is chemical waste, fuel cell waste and/or electrolysis cell waste.

4. The method according to claim 1, wherein the fluorine content of the waste containing fluorine and noble metals lies in the range of 15 to 60 wt. %.

5. The method according to claim 1, wherein the noble metal content of the waste containing fluorine and noble metals lies in the range of 0.5 to 8 wt. %.

6. The method according to claim 1, wherein the chromium corundum material comprises or consists of 80 to 95 wt. % alpha-Al₂O₃, 1 to 20 wt. % Cr₂O₃ and 0 to 5 wt. % SiO₂.

7. The method according to claim 1, wherein the chromium corundum material comprises or consists of 85 to 95 wt. % alpha-Al₂O₃, 2 to 15 wt. % Cr₂O₃ and 0 to 2 wt. % SiO₂.

8. The method according to claim 1, wherein the chromium corundum lining is designed in the form of a ramming mass, as pre-compacted fibers and/or as a chromium corundum brick.

9. The method according to claim 1, wherein the furnace temperature during incineration is in the range of 650 to 950° C. as a continuous temperature.
